(19) United States
(12) Patent Application Publication
(10) Pub. No.: US 2023/0304619 A1
(43) Pub. Date: Sep. 28, 2023

(54) SYSTEM FOR THE FLUID-GUIDING CONNECTION OF AN ELEMENT TO A COUNTERPART, ADAPTER ELEMENT AND ADAPTER HOUSING FOR FLUID-GUIDING CONNECTION AND ADAPTER SYSTEM HAVING THE ADAPTER ELEMENT AND THE ADAPTER HOUSING

(71) Applicant: Argo GmbH, Gräfelfing (DE)

(72) Inventor: Jan ANDREAS, Wesel (DE)

(21) Appl. No.: 18/019,468

(22) PCT Filed: Jul. 29, 2021
(86) PCT No.: PCT/EP2021/071272

§ 371 Date: Feb. 2, 2023

(30) Foreign Application Priority Data
Aug. 3, 2020 (DE) 10 2020 209 735.6

(51) Int. Cl. F16L 41/00; F16L 41/16; F16K 1/38

(52) U.S. Cl. CPC F16L 41/008; F16L 41/16; F16K 1/38

(57) ABSTRACT

The present invention relates to a system (100) for the flow-guiding or fluid-guiding connection of an element (200) to a counterpart 300, comprising: a first seal (110), consisting of a valve body (101) and a first seal element (102) which is arranged in a fluid channel (301), the valve body (101) being configured, by interaction with the seal element (102), to be able to be displaced or moved between an open position, in which a fluid, more particularly gas, can flow through the fluid channel (301), and a closed position, in which no fluid, more particularly gas, can flow through the fluid channel (301), and a second seal (120), which is arranged downstream of the first seal (110) in the fluid channel (301) in a flow-out direction A of the fluid flowing through/out of the fluid channel (301) and is configured to seal a connection region 302 between the fluid channel (301) and the element (200), more particularly to seal same in a gas-tight manner, the second seal (120) being designed such that, when the element (200) is connected to the counterpart (300), the second seal seals the connection region 302 before the first seal (110) can be or is mechanically displaced or moved into the open position.

### TECHNICAL FIELD

The present invention relates to a system, an adapter member, an adapter housing, and an adapter system comprising the adapter member and the adapter housing, all of which are configured to establish a flow-conducting or fluid-conducting, in particular gas-conducting, connection between an element, such as a sensor or system connector, and a counterpart, such as a component selected from the group consisting of: a pressure vessel, a valve, a valve assembly, a valve block and the like. The present invention furthermore relates to a method for connecting an element to a counterpart in a flow-conducting or fluid-conducting, in particular a gas-conducting manner.

### PRIOR ART

Devices for establishing a connection, in particular a flow-conducting or fluid-conducting connection, between an element, such as a pressure sensor, and a counterpart, such as a high-pressure vessel, are known from the prior art. Therein, for example, a pressure sensor for detecting the pressure in the high-pressure vessel is connected to a component (counterpart), such as an on-tank valve (OTV) or a gas handling unit (GHU), or is screwed directly into the high-pressure vessel or gas pressure tank. The pressure sensor can alternatively also be connected into other gas-conducting parts that are directly connected to the high-pressure vessel. Since sealing plays a decisive role in the case of gases, sealing members are typically used, which seal the connection point between the element (pressure sensor) and the counterpart (component). This also applies in particular in the case of high-pressure applications, such as in pipe elements for compressed natural gases or for compressed hydrogen. In particular when sealing hydrogen, appropriate sealing members that offer high diffusion resistance to the hydrogen are of vital importance.

Furthermore, in particular in the case of hydrogen applications, parts such as pressure sensors, pressure gauges, temperature sensors and many other parts installed in hydrogen supply systems must be regularly inspected and demounted. In this regard, it is problematic, in particular in the case of high-pressure systems with a pressure of 700 bar and more, to drain the components, such as valve blocks or pipes, that are connected to the part to be removed. The component (counterpart) must be free of gas and secured in such a manner that a large amount of hydrogen can under no circumstances escape from the system. In particular high-pressure sensors must be replaced annually. In some hydrogen applications, the pressure sensors are screwed directly onto the high-pressure vessels, which means that these must be completely drained before the high-pressure sensor can be removed. This is a difficult, dangerous and expensive matter since after the system has been drained, it must be inerted with nitrogen gas, and only when it has been ensured that there is no oxygen in the system can it be filled with hydrogen. Since the two gases do not mix, this is a time-consuming process and there is always a residual risk of nitrogen remaining in the system.

A further disadvantage of conventional connection techniques for gas-conducting elements is the fact that both the sealing members and the screw members used to create the sealing effect come into direct contact with the medium to be sealed, in particular the gas. This is not dramatic in the case of conventional gases such as natural gases, but can be a major source of danger for connections used for parts in hydrogen applications. Since many materials, in particular metals, are prone to so-called “hydrogen embrittlement” when they come into contact with hydrogen, this, in particular when combined with alternating stress (changes in temperature and tension) and vibrations, can often lead to leaks in the case of known connecting techniques. Since hydrogen is the lightest of all the chemical elements, permanently sealed connection points are difficult to realise.

For example, U.S. Pat. No. 5,528,941 A describes a pressure sensor 10 that can be connected to a fuel tank 40 by means of an adapter. For this purpose, the adapter comprises a housing 4 and a chamber 11 for receiving the sensor. The housing 4 is sealed in the fuel tank 40 by means of an O-ring seal 5. The pressure sensor 10 is also secured and sealed in a cylindrical recess 12 by means of a sealing ring. However, if the pressure sensor 10 must now be removed from the adapter 10 and thus from the recess 12 for inspection or maintenance, a direct connection to the interior of the fuel tank 40 is created, which is why the fuel tank must be completely drained before the pressure sensor 10 is detached.

### DESCRIPTION OF THE INVENTION

In view of the above-described problems when connecting or joining an element to a counterpart, such as a component selected from the group consisting of: a pressure vessel, a valve, a valve assembly, a valve block and the like, it is an object of the present invention to provide a system, an adapter member, an adapter housing, an adapter system comprising the adapter member and the adapter housing as well as a method, which are capable, on the one hand, of allowing the element to be demounted from the counterpart (component) without the need, for example, to reduce the pressure present in the counterpart (draining), and, on the other hand, are capable of taking into account the problems described above, such as hydrogen embrittlement, the occurrence of leakages caused by temperature and tension changes as well as vibrations.

The cited object is solved by a system for connecting/joining an element to a counterpart in a flow-conducting or fluid-conducting manner according to claim 1, an adapter member according to claim 15, an adapter housing according to claim 20, an adapter system according to claim 23, and a method according to claim 24.

Preferred embodiments of the invention are specified in the dependent claims, and the subject matters of the system can be used within the framework of the adapter member, the adapter housing, the adapter system and the method for connecting an element to a counterpart, and vice versa.

One of the basic ideas of the present invention is to provide a system for connecting/joining an element to a counterpart in a flow-conducting or fluid-conducting manner, which system comprises two seals disposed in a fluid channel one behind the other in an outflow direction of a fluid, in particular a gas, out of the counterpart, which fluid channel connects the element to the counterpart in a flow-conducting or fluid-conducting, in particular a gas-conducting manner, the first seal being formed from a valve body and a first sealing member, the valve body being configured to be shifted or movable between an open position, in which a fluid, in particular gas, can flow through the fluid channel, and a closed position, in which no fluid can flow through the channel. The second seal, which is disposed in the fluid channel downstream of the first seal in the outflow direction of the fluid flowing through/flowing out through the fluid channel is configured to seal, in particular in a gas-tight manner, a connecting region between the fluid channel and the element, the second seal being configured such that when connecting/joining the element to the counterpart, it seals the connecting region before the first seal can be/is mechanically shifted or moved into the open position.

A system (coupling system) can thus be provided which, on the one hand, can ensure that before a seal (first seal) sealing a counterpart, in particular a component, is released or opened, an additional or further seal (second seal) can be realised between the same parts, which prevents or minimises the escape into the environment of the gas present, for example stored, in the counterpart when the first seal is released or opened, and which, on the other hand, protects parts of the system, in particular seals, from contact with the fluid, in particular hydrogen, and the associated ageing of the material, in particular hydrogen embrittlement. Minimisation of the outflowing fluid, in particular the gas, when producing or releasing the connection between the element and the counterpart, in particular the component, is extremely advantageous, in particular in the field of explosion protection.

According to one aspect of the present invention, a system for connecting or joining an element, in particular a sensor or a system connector, to a counterpart in a flow-conducting or fluid-conducting, in particular a gas-conducting manner, in particular to a component selected from the group consisting of: a pressure vessel, a valve, a valve assembly, a valve block and the like, comprises: a first seal consisting of a valve body and a first sealing member, said sealing member being disposed in a fluid channel that in particular connects the element to the counterpart in a flow-conducting or fluid-conducting, in particular a gas-conducting manner, and said valve body being configured such that it can be shifted or moved, by means of interaction with the first sealing member, between an open position, in which a fluid, in particular gas, can flow through the fluid channel, and a closed position, in which no fluid, in particular gas, can flow through the fluid channel, and a second seal which is disposed in the fluid channel downstream of the first seal in an outflow direction of the fluid flowing through or flowing out through the fluid channel, and which is configured to seal, in particular in a gas-tight manner, a connecting region between the fluid channel and the element, said second seal being configured such that when connecting or joining the element to the counterpart, it seals the connecting region before the first seal can be or is shifted or moved into the open position, in particular can be or is mechanically shifted or moved into the open position.

In this context, the term “interaction” is to be understood to mean that, by enabling a relative movement, in particular a translatory movement, of the valve body relative to the first valve member, the valve body can be brought into contact, in particular gas-tight contact, with the first sealing member, as a result of which the first seal can be brought into the closed position in which no fluid, in particular gas, can flow through the first seal and thus the fluid channel. On the other hand, when the contact between the valve body and the first sealing member is released by spacing the valve body apart from the first sealing member, the first seal can be brought into the open state in which the fluid can flow through the first seal and the fluid channel.

In this context, the “outflow direction” furthermore describes a direction in which the fluid, in particular the gas, flows out of the counterpart, in particular the component, in which it is pressurised, to the element, in particular the sensor or the system connector, when the first seal is brought into the open position. For example, in the case of a system connector of a high-pressure tank for hydrogen or a plurality of high-pressure tanks that are combined to form a bundle, for example in an exchangeable container or exchangeable cartridge, the system connector can be configured as a quick coupling that enables the high-pressure tank(s) to be connected to a fuel cell system in an uncomplicated manner without hydrogen being able to escape when coupling the high-pressure tank(s) to the system. In this context, the outflow direction is from the high-pressure tanks to the fuel cell system or out of the quick coupling.

Furthermore, the term “mechanical” used here in connection with “can be brought into the open position” describes that the valve body can be or is moved into the open position by means of a mechanically initiated movement, for example by means of contact with a plunger (projection of the element).

It may be advantageous here if the first seal and/or the second seal, in particular the first sealing member and/or the second sealing member, is formed as a radial seal, a resilient seal, an O-ring, a delta ring, a liquid seal, a metal seal and the like, wherein in particular the second seal is preferably formed between an outer surface of the element and an inner surface of the fluid channel. It does not matter whether the second seal, in particular a sealing member (second sealing member) of the second seal, is provided on the inner surface of the fluid channel or the outer surface of the element, as long as it achieves a sealing effect between the inner surface of the fluid channel and the outer surface of the element.

It is furthermore advantageous if the valve body is configured to be brought into contact, in particular gas-tight contact, with a valve seat formed on the first sealing member, the valve seat preferably being in the form of a tapered surface, in particular a conical surface. A seal formed in such a manner is also called a “metal seal”.

A “metal seal” is understood to mean that two elements made of metal are pressed against each other under the influence of force such that a fluid-tight connection is created between the two elements. In such a case, an annular contact surface is usually created between the two elements, through which the fluid to be sealed, in particular gas, can flow if the seal is in the open state.

The valve body can alternatively be configured so as to descend into the first sealing member, which is formed, for example, as a radial seal, in particular an O-ring, and thereby close the fluid channel. If the first seal is to be opened, the valve body must preferably be forced or pressed out of the first sealing member by an adapter body of an adapter member of the element.

It is furthermore advantageous if the valve body has an at least partially conical shape, rounded shape, spherical shape or globular shape, in particular at an end face that is configured to be brought into contact with a valve seat of the first sealing member.

According to a further embodiment, the valve body and the valve seat are configured in such a manner that an annular contact surface is formed, with a central axis of the valve seat and a central axis of the valve body being disposed parallel to one another, in particular coaxially to one another, and the valve body being displaceable parallel to the two central axes, in particular in a mounting direction (opposite to the outflow direction).

It is furthermore preferred that a projection, in particular an annular projection, is formed in the fluid channel, which is configured to receive or support the first sealing member that is preferably annular.

It is furthermore advantageous if the projection forms a stop against which the first sealing member can be fixed and/or pressed, whereby the sealing member can preferably be pressed against the projection by a clamping member. It is preferred if the clamping member is in the form of a clamping nut with an external thread.

It is furthermore preferred that the clamping member comprises an external thread, by means of which the clamping member can be adjusted against the first sealing member, as a result of which the first sealing member can be pressed against the projection, and/or that a portion of the fluid channel extends through the clamping member, in particular through the centre thereof, with in particular the connecting region being formed within said portion of the fluid channel.

It is furthermore advantageous if the element comprises a projection which is preferably cylindrical and is configured to be insertable into the fluid channel, with a distance from an end face of the projection, which is configured to come into or be brought into contact with the valve body, to a second sealing member of the second seal, which is disposed on an outer surface of the projection, being set in such a manner that the second sealing member of the second seal seals the connecting region between the fluid channel and the outer surface, in particular in a gas-tight manner, before the end face comes into or is brought into contact with the valve body, in particular when the element is connected or joined to the counterpart.

It is furthermore preferred that the clamping member and the first sealing member comprise a sealing surface on the end sides respectively facing one another, which create or form a gas-tight contact when the clamping member is pressed against the first sealing member.

According to a further embodiment of the present invention, the valve body is pretensioned by means of a spring element, in particular a spring, against the first sealing member, in particular the valve seat formed therein.

It is furthermore preferred if the valve body is movably, in particular in a translatory manner, received and supported in a recess, and the spring element is provided in a bottom region of the recess, wherein at least the bottom region is sealed with respect to the fluid flowing through the fluid channel by means of a third seal that is preferably provided on an outer surface of the valve body or an inner surface of the recess.

It is advantageous here if the element comprises an adapter body that is configured to be screwed into the counterpart, in particular an adapter housing, by means of an external thread or to be inserted into the counterpart, in particular the adapter housing, and to be fastened thereto by means of at least one fastening element, in particular a plurality of screws, wherein the projection is formed on a side of the adapter body that is facing the counterpart, in particular in the inserted or mounted state.

It can be particularly advantageous if the system, in particular the element or the adapter body of the element, is configured to perform a purely translatory movement, in particular in the mounting direction, during the creation of the gas-tight connection between the element, in particular the adapter body, and the counterpart. In other words, the system can be configured such that no relative rotational movement of the element or the adapter body to the counterpart occurs or is necessary during connection of the element to the counterpart. This makes mounting easier, in particular in the case of long pipe elements provided with a plurality of bends. This constitutes a major advantage over known screw connections, which, in most cases, are screwed into a counterpart via an external thread.

The element, in particular the adapter body, can advantageously be provided with at least two, preferably four, through-holes for receiving fastening screws, the through-holes preferably being provided on a flange projection of the element, in particular of the adapter body, and the through-holes or fastening screws preferably being disposed behind the two seals in the outflow direction of the fluid.

The adapter body can furthermore be formed with an (internal) fluid channel which, in the state in which the element is screwed or inserted in the counterpart, is connected in a flow-conducting or fluid-conducting, in particular a gas-conducting manner to the fluid channel that is preferably formed at least partially in the counterpart, said fluid channel of the adapter body preferably having at least one opening (hole) provided laterally on the outer surface of the element, in particular of the adapter body, via which the fluid channel is connected in a flow-conducting or fluid-conducting, in particular a gas-conducting manner to the fluid channel (412).

According to a further embodiment of the present invention, the adapter body further comprises a fourth seal which is disposed downstream of the first seal and the second seal in the outflow direction and which is configured to provide a seal, in particular a gas-tight seal, between an outer surface of the adapter body (element) and an inner surface of the fluid channel.

It is furthermore advantageous if the element and the adapter body are integrally formed or if the adapter body is part of an adapter member into which the element can be inserted in a gas-tight manner so as to be connectable or joinable in a flow-conducting or fluid-conducting manner, in particular a gas-conducting manner, to the counterpart, in particular to an adapter housing integrated or incorporated in the counterpart.

The present invention furthermore relates to an adapter member for connecting or joining an element, in particular a sensor or a system connector, to a counterpart in a flow-conducting or fluid-conducting, in particular a gas-conducting manner, in particular to a component from the group consisting of: a pressure vessel, a valve, a valve assembly, a valve block and the like, preferably for use in the system described above, comprising: an adapter body that is configured to be screwed into the counterpart by means of an external thread or to be inserted into the counterpart and fastened thereto by means of at least one fastening element, preferably a plurality of screws, a projection that is configured to be insertable into a fluid channel formed in the counterpart and to be brought into contact with a valve body of a first seal disposed in the fluid channel in order to bring the first seal into an open position in which a fluid, in particular a gas, can flow through the fluid channel into the element, and a second seal, which is disposed in the fluid channel downstream of the first seal in an outflow direction of the fluid flowing through or flowing out through the fluid channel, and which is configured to seal, in particular in a gas-tight manner, a connecting region between the fluid channel and the adapter body, wherein the second seal is configured such that when connecting or joining the element, in particular the adapter member, to the counterpart, it seals the connecting region before the first seal is shifted or moved into the open position by contact of the projection with the valve body.

It is furthermore preferred if the second seal, in particular a second sealing member, is formed as a radial seal, a resilient seal, an O-ring, a delta ring, a liquid seal, a metal seal and the like, in particular between an outer surface of the adapter body and an inner surface of the fluid channel. The second sealing member is preferably configured on the outer surface of the adapter body or the inner surface of the fluid channel.

It is furthermore advantageous if the second seal is formed as a metal seal or a curved-surface seal, with a valve body portion being formed preferably on the adapter body, which valve body portion at least partially has a conical shape, rounded shape, spherical shape or globular shape, and is configured to be brought into contact, in particular gas-tight contact, with a second valve seat provided in the counterpart, in particular in the adaptor housing or in the clamping member, which second valve seat preferably has a tapered shape, in particular a conical shape.

It is particularly advantageous if, in the sealed state, the valve body of the second seal is pressed against the valve seat formed in the counterpart via a screw connection, in particular at least two, preferably four, clamping screws.

A device or screw connection can be realised in this manner, wherein with a predetermined tightening torque of the clamping screws, a relatively precise pressing of the valve body against the valve seat can be realised, such that a sealing contact of the corresponding elements can be ensured over a wide temperature range, and documentation and thus certification is possible using the applied tightening torques.

According to a further embodiment of the present invention, the valve body and/or the valve seat is made from a metal, in particular a steel material, preferably a stainless steel material, with the valve seat preferably being made of a harder material than the valve body.

If the valve seat is made of a harder material than the valve body, it can be ensured that in the event of a possible plastic deformation when pressing the valve body against or into the valve seat, the valve body will plastically deform, which can easily be replaced.

It is furthermore advantageous if a distance from an end face of the projection of the adapter member, which is configured to come into contact with the valve body, to a second sealing member of the second seal, is set or selected in such a manner that the second sealing member of the second seal seals the connecting region between the fluid channel and the outer surface, in particular in a gas-tight manner, before the end face (when connecting or joining the element, in particular the adapter member, to the counterpart) comes into contact with the valve body.

According to a further embodiment of the present invention, the adapter member is integrated, preferably in one piece, into the element, in particular the sensor or the system connector.

The present invention furthermore relates to an adapter housing, in particular an adapter housing that can be integrated into a counterpart, for connecting or joining an element, in particular a sensor or a system connector, to a counterpart in a flow-conducting or fluid-conducting manner, in particular to a component selected from the group consisting of: a pressure vessel, a valve, a valve assembly, a valve block and the like, preferably for use in the system described above, comprising: a first seal consisting of a valve body and a first sealing member, said first sealing member being disposed in a fluid channel that connects in particular the element to the counterpart in a flow-conducting or fluid-conducting, in particular gas-conducting manner, and said valve body being configured such that it can be shifted or moved, by means of interaction with the sealing member, between an open position, in which a fluid, in particular gas, can flow through the fluid channel, and a closed position, in which no fluid, in particular gas, can flow through the fluid channel, and a second seal which is disposed in the fluid channel downstream of the first seal in an outflow direction of the fluid flowing through or flowing out through the fluid channel, and which is configured to seal, in particular in a gas-tight manner, a connecting region between the fluid channel and the element, said second seal being configured such that when connecting or joining the element to the counterpart, it seals the connecting region, in particular in a gas-tight manner, before the first seal can be or is shifted or moved into the open position.

It is preferred if the valve body is configured to be shiftable or movable between the closed position and the open position by contact with a projection or plunger, in particular with an end face of the projection of the element.

It is furthermore advantageous if the valve body is pressed under force against the first seal by means of a spring element, in particular a spring, which forces the valve body into the closed position of the first seal.

It is particularly preferred that the adapter housing is formed integrally, in particular in one piece, with the counterpart, in particular the component selected from the group consisting of: a pressure vessel, a valve, a valve assembly, a valve block and the like.

The present invention furthermore relates to an adapter system for connecting or joining an element, in particular a sensor or a system connector, to a counterpart in a flow-conducting or fluid-conducting manner, in particular to a component selected from the group consisting of: a pressure vessel, a valve, a valve assembly, a valve block and the like comprising: the above-described adapter member as well as the above-described adapter housing, the adapter member and the adapter housing being configured as a functional group that can be disposed between the element and the counterpart in a flow-conducting or fluid-conducting manner, and preferably being connectable, in particular screwable, (in a gas-tight manner) to the element or the counterpart, respectively

The system according to the invention for connecting an element to a counterpart in a flow-conducting or fluid-conducting, in particular gas-conducting manner enables a contact point or connection point to be reliably sealed when removing the element from the counterpart by means of a simple and inexpensive design. The system furthermore advantageously enables documentation and certification. It is therefore particularly suitable for connecting elements such as sensors and system connectors in systems in which hydrogen, in particular compressed hydrogen, or compressed natural gas is used. Such systems, which are exposed to particularly high temperature fluctuations, tension fluctuations and vibrations, are found in particular in vehicles in which, for example, hydrogen at pressures of 700 bar and more or natural gas at typically 260 bar is used as fuel to power the vehicle, for example via a fuel cell.

In the context of the present invention, the term “vehicle” or “means of transport” or other similar terms includes motor vehicles in general, such as passenger vehicles including sports utility vehicles (SUVs), buses, lorries, various commercial vehicles, water vehicles including various boats and ships, aircraft, aerial drones and the like, hybrid vehicles, electric vehicles, plug-in hybrid electric vehicles, hydrogen vehicles and other alternative vehicles. As stated herein, a hybrid vehicle is a vehicle with two or more energy sources, for example, petrol-powered and simultaneously electric-powered vehicles.

The present invention furthermore relates to a method for connecting an element, in particular a sensor or a system connector, to a counterpart in a flow-conducting or fluid-conducting, in particular gas-conducting manner, in particular to a component selected from the group consisting of: a pressure vessel, a valve, a valve assembly, a valve block and the like, preferably using the above-described system or the above-described adapter system, comprising:
inserting or screwing the element, in particular an adapter body, into the counterpart, in particular into an adapter housing,
creating a sealing effect of a second seal which is disposed in the fluid channel downstream of the first seal in an outflow direction A of a fluid flowing through or flowing out through the fluid channel, wherein the second seal is configured to seal a connecting region between the fluid channel and the element, in particular the adapter body, and
opening or releasing the first seal by preferably moving a valve body of the first seal out of engagement or contact with a first sealing member of the first seal,
wherein the sealing effect of the second seal between the fluid channel and the element is created before the first seal is allowed to open or release, in particular is mechanically enabled.

In other words, according to the method of the invention, opening of the first seal is prevented until the second seal seals the fluid channel against the element to be connected or joined to the counterpart, thereby preventing the pressurised fluid in the counterpart 300 from escaping into the environment.

As already indicated above, the system, the adapter member, the adapter housing and the adapter system for connecting an element to a counterpart in a flow-conducting or fluid-conducting manner can be used for the described method for connecting an element to a counterpart in a flow-conducting or fluid-conducting manner. The further features disclosed in connection with the above description of the device can therefore also be applied to the method. The same is true vice versa for the method.

### BRIEF DESCRIPTION OF THE FIGURES

Further features and advantages of a device, a use and/or a method are apparent from the following description of embodiments with reference to the accompanying figures. In these figures:

FIG. 1 schematically shows a known connector for a pressure sensor in a fuel tank,

FIG. 2 schematically shows an embodiment of a system according to the invention for connecting an element to a counterpart in a flow-conducting or fluid-conducting manner, which is in the open state,

FIG. 3 schematically shows the embodiment shown in FIG. 1 of a system according to the invention for connecting an element to a counterpart in a flow-conducting or fluid-conducting manner, which is in the closed state,

FIG. 4 schematically shows an embodiment of an adapter member according to the invention for connecting an element to a counterpart in a flow-conducting or fluid-conducting manner,

FIG. 5 schematically shows an embodiment of an adapter housing according to the invention for connecting an element to a counterpart in a flow-conducting or fluid-conducting manner, which is in the closed state, and

FIG. 6 schematically shows a second embodiment of a system according to the invention for connecting an element to a counterpart in a flow-conducting or fluid-conducting manner, which in the open state.

### DESCRIPTION OF EMBODIMENTS

Identical reference numbers that are used in different figures designate identical, corresponding or functionally similar elements.

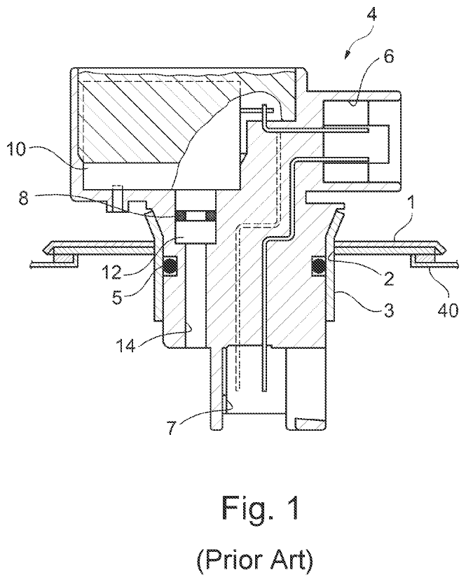

FIG. 1 schematically shows a known connector for a pressure sensor 10 in a fuel tank 40. As FIG. 1 shows, the described connector is mounted on a base plate 1 of a fuel tank 40 in a vehicle. The base plate 1 is used to close an opening in the fuel tank 40 and is provided with a connector piece mounting hole 2. A metal sleeve 3 is fitted into the hole 2 and attached thereto by means of welding or the like. A connector housing 4 is fitted into the sleeve 3 in a sealed manner by means of an O-ring 5. The connector housing 4 is made of a synthetic resin material and is provided with an upper connector opening 6 on an upper side surface and with a lower connector opening 7 on a lower end face, which are used to receive a further connector. The pressure sensor 10 is embedded in an upper region of the connector housing 4 and behind the upper connector opening 6. The pressure sensor 10 is furthermore provided on its underside with a downwardly projecting pressure sensing portion 10a.

A receiving chamber 11 for receiving the pressure sensor 10 is furthermore formed in the upper region of the connector housing 4. A passage 12 having a larger diameter for receiving the sensing portion 10a of the pressure sensor 10 is formed in a bottom region of the connector housing 4. A passage 14 having a smaller diameter for introducing the internal pressure in the fuel tank 40 into the sensing portion 10a of the pressure sensor 10 is also formed in the bottom region and extends from a lower end of the passage 12 having a larger diameter to a lower surface of the bottom region. An O-ring 8 is provided to seal the pressure sensor 10 in the passage 12 having a larger diameter.

As is apparent from FIG. 1, when the pressure sensor 10 is removed, a completely open fluid channel between the interior of the fuel tank 40 is created, as a result of which the fuel tank must be completely emptied before the pressure sensor 10 is removed in order to prevent the medium stored therein, in particular fuel, from escaping. This applies in particular to fuel tanks for storing pressurised media such as compressed gases, in particular compressed hydrogen.

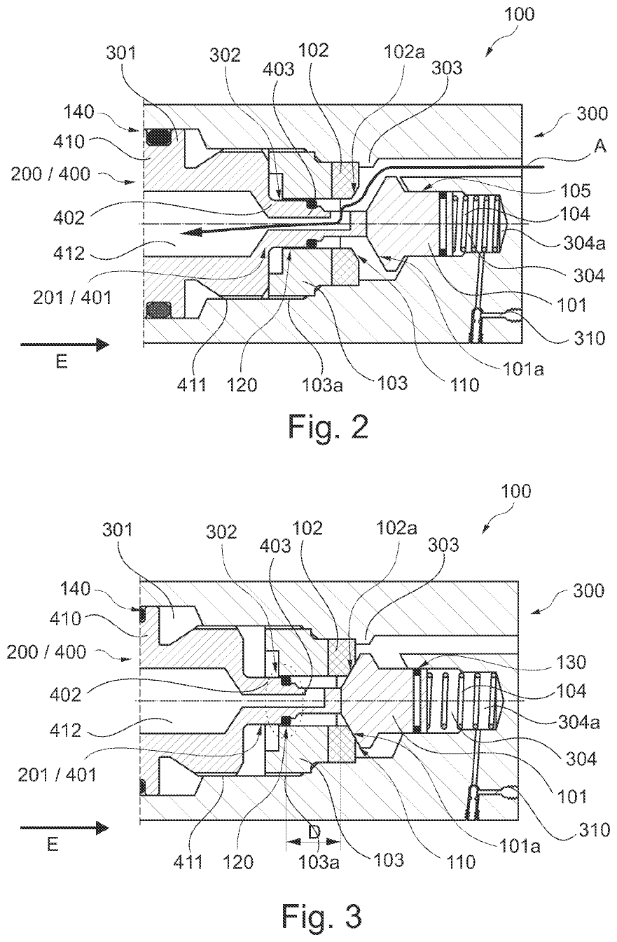

FIG. 2 schematically shows an embodiment of a system 100 according to the invention for connecting an element 200 to a counterpart 300 in a flow-conducting or fluid-conducting manner, wherein the system is shown in the open state and the connected state. The element 200 may be, for example, a sensor, in particular a pressure sensor, which is to be connected to a counterpart such as a valve block (for example a gas handling unit (GHU)).

As is furthermore apparent from FIG. 2, the system 200 comprises a first seal 110 that is formed from a valve body 101 and a first sealing member 102, said first sealing member 102 being disposed in a fluid channel 301 that connects the element 200, in particular the pressure sensor, to the counterpart 300, in particular the valve block, in a flow-conducting or fluid-conducting, in particular gas-conducting manner.

In this manner, the element 200, in particular the pressure sensor, can be connected to a flow-conducting or fluid-conducting, in particular gas-conducting, pipe or part within the counterpart 300, in particular the valve block. The fluid channel 301 thus allows a pressure present in the valve block, for example, or a pressure present in a part communicating with the valve block to be determined by means of the pressure sensor.

The first sealing member 102 is formed as a disc, provided in the centre of which is a through-hole which forms a part of the fluid channel 301. The disc is furthermore formed with a valve seat 102a, which in particular surrounds the through-hole and is configured to come into contact with the valve body 101 so as to realise a fluid-tight, in particular gas-tight, seal. As is apparent from FIG. 2, the valve seat 102a tapers in the direction of the through-hole and preferably has a conical shape.

In order to fix the first sealing member 102, in particular the disc, in the fluid channel 301, the fluid channel 301 is formed with an annular projection 303 which protrudes inwardly into the fluid channel 301 and is configured to support the first sealing member 102 from the left side (in FIG. 2). In other words, the projection 300 is disposed in front of the first sealing member 102 in an outflow direction A of the fluid through the fluid channel 301, i.e. from the counterpart 300 in the direction of the element 200. On the opposite side of the first sealing member 102, the fluid channel 301 is provided with an internal thread into which a clamping member 103 is screwed by means of an external thread 103a. The clamping member 103 is used to press the sealing member 102 against the projection 303, whereby on the one hand the first sealing member 102 can be spatially fixed and on the other hand a gas-tight contact between the first sealing member 102 and clamping member 103 can be realised. For this purpose, the first sealing member 102 and the clamping member 103 preferably each have flat, abutting contact surfaces.

As shown in FIG. 2, the clamping member 103 also comprises a central through-hole that is aligned with the through-hole of the first sealing member 102 and accordingly also forms a part or region of the fluid channel 301.

In the shown embodiment, the valve body 101 furthermore has a mushroom shape, with a head side of the valve body 101, which faces the first sealing member 102, having a conical shape. In the shown embodiment, the conical end face 101a of the valve body 101 has a frustum shape. In other words, the valve body 101 has the shape of a truncated cone with a flat stop surface.

The valve body 101 is received in a recess 304 formed in the counterpart 300, said valve body 101 being received in the recess 304 in particular in such manner that it can perform an axial or translatory movement, in particular in the direction of the first sealing member 102. In the recess 304, which is cylindrical in shape, a spring 104, in particular a compression spring, is provided in a bottom region 304a of the recess 304, which acts against the valve body 101. The valve body 101 is pretensioned against the first sealing member 102 by the spring 104, as a result of which the valve body 101 is forced into a closed state by the spring 104, in which the valve body 101 is in a fluid-tight, in particular gas-tight, state with the first sealing member 102, in which no fluid, in particular gas, can flow through the fluid channel 301. This state is shown in particular in FIG. 3.

If the element 200, in particular the pressure sensor, is now supposed to be connected to the counterpart 300, an adapter member 400, which can be part of the element 200 or is a separate adapter member that is connected in a fluid-tight or gas-tight manner to the element 200, in particular the pressure sensor, is inserted into the fluid channel 301. In the embodiment shown in FIG. 2, the adapter member 400 comprises an external thread 411, via which it can be screwed into the counterpart 300, in particular into the fluid channel 301. As is furthermore apparent from FIG. 2, the adapter member 400 is provided with a projection 402 or contact member (plunger) which is formed on a side of the adapter member 400 facing the counterpart 300. In the state shown in FIG. 2, the adapter member 400 is already completely screwed into the counterpart 300 and a truncated end face 403 of the projection 402 is in contact with the truncated end face of the valve body 101. By screwing the adapter member 400 into the counterpart 300, the adapter member 400 moves deeper into the counterpart 300, in particular the fluid channel 301, in an installation direction E (mounting direction), thereby pushing the valve body against the spring 104 into an open position in which the fluid, in particular the gas, can flow through the fluid channel 301 into the element 200, as shown by the arrow A. In order to connect the element 200, in particular the pressure sensor, to the counterpart 300 in a flow-conducting manner, the adapter member 400 is formed in a hollow manner or comprises a fluid channel 412 and has an opening laterally on an outer surface of the projection 402, which creates a connection to the fluid channel 301 of the counterpart.

As FIG. 2 also shows, the system 100 furthermore comprises a second seal 120 which is disposed in the fluid channel 301 downstream of the first seal 110 in the outflow direction A of the fluid flowing through or out through the fluid channel. The second seal 120 is configured so as to seal, in particular in a gas-tight manner, a connecting region 302 between the fluid channel 301 and the element 200. The connecting region 302 is to be understood as a region in which an inner surface 301a of the fluid channel 301 comes into contact with an outer surface 401 of the projection 402 of the adapter member 400. In the shown embodiment, the second seal 120, in particular a second sealing member 121 of the second seal 120, is formed as an O-ring which is received in a groove or projection of the adapter member 400. In the shown embodiment, the connecting region 302 is disposed such that it is located within the clamping member 103.

FIG. 3 schematically shows the embodiment shown in FIG. 1 of a system 100 according to the invention for connecting an element to a counterpart in a flow-conducting or fluid-conducting manner, the first seal 101 being in the closed state. If, starting from the open state shown in FIG. 2, the adapter member 400 is now slowly pulled out of or unscrewed from the counterpart 300, the valve body 101 comes back into contact with the first sealing member 102, thereby closing the fluid channel 301. As is apparent from FIG. 3, this closed state of the first seal 101 and the fluid channel 301 is achieved before the second sealing member 121 of the second seal 120, namely the O-ring, is pulled out of the clamping member 103, in particular out of the connecting region 302. In FIG. 3, the second seal 120 is accordingly still in the sealed state.

In other words, the second seal 120 is configured such that when the element 200 is removed from the counterpart 300, it seals the connecting region 302 at least until the first seal is shifted or moved into the closed position. On the other hand, when the element 200 is connected to the counterpart 300, the second seal 120 is configured such that when connecting the element 200 to the counterpart 300, it seals the connecting region before the first seal is shifted or moved into the open position.

For this purpose, a distance D from the end face 403 of the projection 402 to the second sealing member 121 of the second seal 120 is set such that the second sealing member 121 seals the connecting region 302 between the fluid channel 301 and the outer surface 401 before the end face 403 of the element 200 comes into contact with the valve body 101, in particular the truncated end face thereof, thereby ensuring that the second seal 120 seals before the first seal 110 is opened or brought into a non-sealing state. In other words, before the valve body 101 is lifted off the valve seat 102a against the spring 104.

As is furthermore apparent in FIGS. 2 and 3, a third seal 130 is provided in the recess 304, which seals the recess 304 from the fluid flowing through the fluid channel 301, as a result of which damaging effects of the fluid, such as hydrogen embrittlement, on the spring element 104 can be prevented.

The adapter member 400, in particular an adapter body 410 of the adapter member 400, furthermore comprises a fourth seal. A fourth sealing member 141 of the fourth seal 140 is also formed as an O-ring, which realises a gas-tight seal between an outer surface of the adapter body 410 (outer surface of the adapter member) and the fluid channel 301, as a result of which the gas-tightness of the system 100 can be further improved.

It is also apparent in FIGS. 2 and 3 that the fluid channel 301 in the counterpart 300 is arranged at least partially asymmetrical or out of alignment with the recess 304 for the valve body 101. This particular arrangement and the fact that the third seal 130 seals the receiving area of the valve body 101 within the recess 304 from the gas flowing through the fluid channel 301 lead to the advantage that the inherent pressure of the fluid or gas does not act on the underside of the valve body 101, as a result of which the pressure force by the adapter member 400 that is required to open the first seal 110 can be reduced. As shown in FIGS. 2 and 3, an annular surface of the valve body 101, which faces away from the valve seat 102a, is also kept minimal, as a result of which the pressure force required to open the first seal 110 can be further reduced since an area of application of the inherent pressure of the fluid or gas is minimised. Furthermore, the counterpart 300 is provided with a test channel 310 that connects the recess 304 to the environment, through which any fluid that may be leaking through the third seal 130 can be drained at regular intervals.

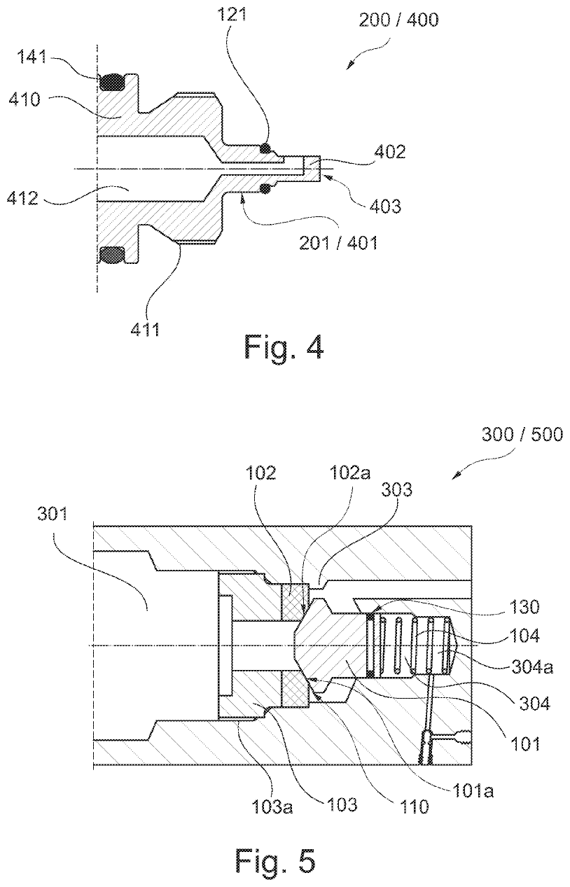

FIG. 4 schematically shows an embodiment of an adapter member 400 according to the invention for connecting an element 200 to a counterpart 300 in a flow-conducting or fluid-conducting manner. The shown adapter member 400 comprises an adapter body 410, which has an elongated cylindrical shape and is provided with an external thread 411 on an outer surface 201, by means of which the adapter member 400 can be screwed into the counterpart 300. The adapter member 400 can be integrated in the element 200, in particular the sensor, or can be configured as a separate part that can be connected to the element 200 in a gas-tight manner.

As is furthermore apparent from FIG. 4, the adapter member 400, in particular the adapter body, comprises a projection 402 which also has an elongated cylindrical shape and is configured to be insertable or introducible into a fluid channel 301 formed in the counterpart 300. In the shown embodiment, a sealing member 121 (second sealing member) of a seal 120 (second seal) is furthermore provided on the outer surface 401 of the projection 402, which, in the state in which the adapter member 400 is inserted in the counterpart 300, serves to form a gas-tight seal between the fluid channel 301, in particular a connecting region 302 provided in the fluid channel 301, and the outer surface 401 of the projection 402. As FIG. 4 also shows, the adapter body 410 is provided with a fluid channel 412 that runs centrally through the adapter body 410 and is configured to connect the element 200 that is joined to the adapter body 410 to the counterpart 300 in a flow-conducting manner. For this purpose, a hole is provided on the outer surface 401 of the projection 402, which connects the internal fluid channel 412 with the fluid channel 301 formed in the counterpart. For this purpose, a plurality of holes can also be arranged on the outer surface 401 of the projection 402.

It is also apparent from FIG. 4 that the projection 402 has a flat end face 403 that is configured to be brought into contact with a valve body 101 of a first seal 110 which is provided in the fluid channel 301 of the counterpart 300 in order to bring the first seal 110 into an open position in which a fluid can flow through the fluid channel 301 from the counterpart 300 to the element 200. The second sealing member 121 is disposed on the adapter body 410 in such a manner that when screwing the adapter member 400 into the counterpart 300, the second seal 120 forms a fluid-tight or gas-tight seal between the adapter member 400 and the counterpart 300 before the end face 403 of the adapter body 410 comes into contact with the valve body 101, thereby bringing the first seal 110 into the open position.

FIG. 5 schematically shows an embodiment of an adapter housing 500 according to the invention for connecting an element 200 to a counterpart 300 in a flow-conducting or fluid-conducting manner, said adapter housing being shown in a closed position or state. The adapter housing 500 shown in FIG. 5 substantially corresponds to the counterpart 300 shown in FIGS. 2 and 3. It is accordingly possible on the one hand to integrate the adapter housing 500 directly into the counterpart 300, or to configure it as a separate component which can be connected to the counterpart 300 in a fluid-tight or gas-tight manner. In the shown embodiment, the adapter housing 500 is integrated directly in the counterpart 300. The adapter housing 500 is provided with the fluid channel 301, the recess 304 and an internal thread. As already described above, the valve body 101 of the first seal 110 is received in the recess 304 in such a manner that it can move in a translatory manner in the insertion direction E of the adapter member 400. A projection 303 is furthermore provided in the fluid channel 301, which acts as a stop or stopper for the first sealing member which, in the shown embodiment, is formed as a disc with a valve seat 102a. The valve body 101 is pretensioned against the first sealing member 102 by a spring 104, as a result of which the first sealing member 102 is closed in the non-actuated state. As furthermore described above, the first sealing member 102 is fixed in the adapter housing 500 by means of a clamping member 103. Finally, a third seal 130 is provided in the adapter housing 500, which is in the form of an O-ring and is used to seal the recess 304 from the fluid flowing through the fluid channel 301.

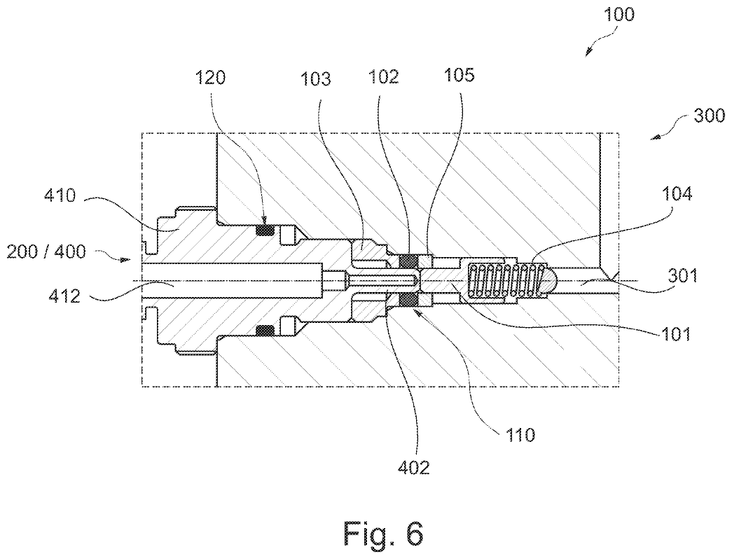

FIG. 6 schematically shows a second embodiment of a system 100 according to the invention for connecting an element 200 to a counterpart 300 in a flow-conducting or fluid-conducting manner, the system 100 being shown in the open state. The second embodiment comprises substantially the same parts/components. The only difference is that the first seal 110 is not in the form of a metal seal, as in the first embodiment, but is rather configured as a resilient seal with a first sealing member 102 in the form of an O-ring. In this embodiment, the valve body 101 descends into the O-ring 102 and thus seals the fluid channel 301. The O-ring 102 is supported in the fluid channel 301 by a support ring 105 and is fixed by a clamping member 103. In this case, the clamping member 103 also serves as a support member for the O-ring 102. If the adapter member 400, in particular the projection 402 of the adapter body 410, is now inserted into the counterpart 300, in particular the adapter housing 500, the projection 402 of the adapter body 410 penetrates the O-ring 102, thereby causing the valve body 101 to be pushed out of the O-ring 102 against the spring force of the spring 104, as a result of which the first seal 110 is brought into the open position and a fluid can thus flow out of the counterpart 300 into the element 200.

As FIG. 6 furthermore shows, this embodiment is also provided with a second seal 120 which, when connecting the element 200 to the counterpart 300, seals the fluid channel 301 against the adapter member 400 before the first seal 110 is moved into the open position.

### LIST OF REFERENCE NUMBERS

100 System (coupling system)
101 Valve body
101a End face
102 First sealing member
102a Valve seat
103 Clamping member (clamping nut)
103a External thread of the clamping member
104 Spring (spring element)
105 Support ring
110 First seal
120 Second seal
121 Second sealing member
130 Third seal
131 Third sealing member
140 Fourth seal
141 Fourth sealing member
200 Element (gas sensor)
201 Outer surface
300 Counterpart (component)
301 Fluid channel
301a Inner surface of the fluid channel
302 Connecting region
303 Projection (stopper)
304 Recess (valve body receptacle)
304a Bottom region (spring receptacle)
400 Adapter member
401 Outer surface of the projection
402 Projection (contact member, plunger)
403 End face of the projection
410 Adapter body
411 External thread
412 Fluid channel (adapter body)
500 Adapter housing
600 Adapter system
A Outflow direction
E Installation direction

1. A system for connecting an element, in particular a sensor or a system connector, to a counterpart in a flow-conducting or fluid-conducting manner, in particular to a component selected from the group consisting of: a pressure vessel, a valve, a valve assembly, a valve block and the like, comprising:
a first seal consisting of a valve body and a first sealing member that is disposed in a fluid channel wherein the valve body is configured such that it can be shifted or moved, by means of interaction with the sealing member, between an open position, in which a fluid, in particular gas, can flow through the fluid channel, and a closed position, in which no fluid, in particular gas, can flow through the fluid channel, and
a second seal which is disposed in the fluid channel downstream of the first seal in an outflow direction (A) of the fluid flowing though or flowing out through the fluid channel and which is configured to seal, in particular in a gas-tight manner, a connecting region between the fluid channel and the element, wherein
the second seal is configured such that when connecting the element to the counterpart it seals the connecting region before the first seal can be or is shifted or moved into the open position.

2. The system according to claim 1, wherein the first seal and/or the second seal is formed as a radial seal, a resilient seal, an O-ring, a delta ring, a liquid seal, a metal seal and the like, wherein in particular the second seal is formed between an outer surface of the element and an inner surface of the fluid channel.

3. The system according to claim 1, wherein the valve body is configured to be brought into contact, in particular into gas-tight contact, with a valve seat formed on the first sealing member, said valve seat preferably being in the form of a tapered surface, in particular a conical surface.

4. The system according to one of the preceding claim 1, wherein the valve body has an at least partially conical shape, rounded shape, spherical shape or globular shape, in particular at an end face that is configured to be brought into contact with a valve seat of the first sealing member.

5. The system according to claim 1, wherein a projection in particular an annular projection, is formed in the fluid channel, which is configured to receive or support the first sealing member that is preferably annular, and which forms a stop against which the first sealing member can be fixed and/or pressed, wherein the sealing member can preferably be pressed against the projection by a clamping member.

6. The system according to claim 5, wherein the clamping member comprises an external thread, by means of which the clamping member can be adjusted against the first sealing member, as a result of which the first sealing member can be pressed against the projection, and/or
a portion of the fluid channel extends through the clamping member in particular through the centre thereof, wherein in particular the connecting region is formed within said portion of the fluid channel.

7. The system according to claim 1, wherein the element comprises a projection which is preferably cylindrical and is configured to be insertable into the fluid channel, wherein a distance (D) from an end face of the projection, which is configured to come into contact with the valve body, to a second sealing member of the second seal, which is disposed on an outer surface of the projection, is set in such a manner that the second sealing member of the second seal seals the connecting region between the fluid channel and the outer surface, in particular in a gas-tight manner, before the end face comes into contact with the valve body.

8. The system according to claim 6, wherein the clamping member and the first sealing member comprise a sealing surface on the end sides respectively facing one another, which create a gas-tight contact when the clamping member is pressed against the first sealing member.

9. The system according to one of the preceding claim 1, wherein the valve body is pretensioned by means of a spring element, in particular a spring, against the first sealing member, in particular the valve seat formed therein.

10. The system according to one of the preceding claim 1, wherein the valve body is movably, in particular in a translatory manner, received and supported in a recess, and the spring element is provided in a bottom region of the recess, wherein at least the bottom region is sealed with respect to the fluid flowing through the fluid channel by means of a third seal that is preferably provided on an outer surface of the valve body or an inner surface of the recess.

11. The system according to claim 1, wherein the element comprises an adapter body that is configured to be screwed into the counterpart, in particular an adapter housing, by means of an external thread or to be inserted into the counterpart in particular the adapter housing and to be fastened thereto by means of at least one fastening element, in particular a plurality of screws, wherein the projection is formed on a side of the adapter body that is facing the counterpart.

12. The system according to claim 11, wherein the adapter body is formed with an internal fluid channel which, in the state in which the element is screwed or inserted in the counterpart, is connected in a flow-conducting or fluid-conducting manner to the fluid channel that is preferably formed at least partially in the counterpart said fluid channel preferably having at least one opening provided laterally on the outer surface of the element.

13. The system according to claim 11, wherein the adapter body further comprises a fourth seal which is disposed downstream of the first seal and the second seal in the outflow direction (A), and which is configured to provide a seal, in particular a gas-tight seal, between an outer surface of the adapter body and an inner surface of the fluid channel.

14. The system according to claim 11, wherein the element and the adapter body are integrally formed or the adapter body is part of an adapter member into which the element can be inserted in a gas-tight manner so as to be connectable to the counterpart in a flow-conducting or fluid-conducting manner, in particular to be connectable to an adapter housing integrated in the counterpart.

15. An adapter member for connecting an element, in particular a sensor or a system connector, to a counterpart in a flow-conducting or fluid-conducting manner, in particular to a component selected from the group consisting of: a pressure vessel, a valve, a valve assembly, a valve block and the like, preferably for use in the system according to one of the preceding claims, comprising:
an adapter body that is configured to be screwed into the counterpart by means of an external thread or to be inserted into the counterpart and fastened thereto by means of at least one fastening element, preferably a plurality of screws,
a projection that is configured to be insertable into a fluid channel formed in the counterpart and to be brought into contact with a valve body of a first seal disposed in the fluid channel in order to bring the first seal into an open position in which a fluid, in particular a gas, can flow through the fluid channel into the element, and
a second seal which is disposed in the fluid channel downstream of the first seal in an outflow direction (A) of the fluid flowing through or flowing out through the fluid channel, and which is configured to seal, in particular in a gas-tight manner, a connecting region between the fluid channel and the adapter body wherein
the second seal is configured such that when connecting the element, in particular the adapter member, to the counterpart, it seals the connecting region before the first seal is shifted or moved into the open position by contact of the projection with the valve body.

16. The adapter member according to claim 15, wherein the second seal, in particular a second sealing member, is formed as a radial seal, a resilient seal, an O-ring, a delta ring, a liquid seal, a metal seal and the like, in particular between an outer surface of the adapter body and an inner surface of the fluid channel.

17. The adapter member according to claim 15, wherein the second seal is formed as a metal seal or a curved-surface seal, wherein a valve body portion is preferably formed on the adapter body, which valve body portion at least partially has a conical shape, rounded shape, spherical shape or globular shape, and is configured to be brought into contact, in particular gas-tight contact, with a second valve seat provided in the counterpart, which second valve seat preferably has a tapered shape, in particular a conical shape.

18. The adapter member according to claim 15, wherein a distance (D) from an end face of the projection of the adapter member, which is configured to come into contact with the valve body, to a second sealing member of the second seal is set in such a manner that the second sealing member of the second seal seals the connecting region between the fluid channel and the outer surface, in particular in a gas-tight manner, before the end face comes into contact with the valve body.

19. The adapter member according to claim 15, wherein the adapter member is integrated, preferably in one piece, into the element, in particular the sensor or the system connector.

20. An adapter housing in particular an adapter housing that can be integrated into the counterpart, for connecting an element, in particular a sensor or a system connector, to a counterpart in a flow-conducting or fluid-conducting manner, in particular to a component selected from the group consisting of: a pressure vessel, a valve, a valve assembly, a valve block and the like, preferably for use in the system according to claim 1, comprising:
a first seal consisting of a valve body and a first sealing member that is disposed in a fluid channel wherein the valve body is configured such that it can be shifted or moved, by means of interaction with the sealing member, between an open position, in which a fluid, in particular gas, can flow through the fluid channel, and a closed position, in which no fluid, in particular gas, can flow through the fluid channel, and
a second seal which is disposed in the fluid channel downstream of the first seal in an outflow direction of the fluid flowing through or flowing out through the fluid channel and which is configured to seal, in particular in a gas-tight manner, a connecting region between the fluid channel and the element, wherein
the second seal is configured such that when connecting the element to the counterpart it seals the connecting region before the first seal can be/is shifted or moved into the open position.

21. The adapter housing according to claim 20, wherein the valve body is configured to be shiftable or movable between the open position and the closed position by contact with a projection of the element, in particular with an end face of the projection.

22. The adapter housing according to claim 20, wherein the adapter housing is formed integrally, in particular in one piece, with the counterpart, in particular the component selected from the group consisting of: a pressure vessel, a valve, a valve assembly, a valve block and the like.

23. An adapter system for connecting an element, in particular a sensor or a system connector, to a counterpart in a flow-conducting or fluid-conducting manner, in particular to a component selected from the group consisting of: a pressure vessel, a valve, a valve assembly, a valve block and the like, comprising:
the adapter member according to claim 15, and
an adapter housing, in particular an adapter housing that can be integrated into the counterpart, for connecting an element, in particular a sensor or a system connector, to a counterpart in a flow-conducting or fluid-conducting manner, in particular to a component selected from the group consisting of: a pressure vessel, a valve, a valve assembly, a valve block and the like, preferably for use in the system according to claim 1, comprising:
a first seal consisting of a valve body and a first sealing member that is disposed in a fluid channel, wherein the valve body is configured such that it can be shifted or moved, by means of interaction with the sealing member, between an open position, in which a fluid, in particular gas, can flow through the fluid channel, and a closed position, in which no fluid, in particular gas, can flow through the fluid channel, and
a second seal which is disposed in the fluid channel downstream of the first seal in an outflow direction (A) of the fluid flowing through or flowing out through the fluid channel, and which is configured to seal, in particular in a gas-tight manner, a connecting region between the fluid channel and the element, wherein
the second seal is configured such that when connecting the element to the counterpart, it seals the connecting region before the first seal can be/is shifted or moved into the open position, wherein the adapter member and the adapter housing are configured as a functional group that can be disposed between the element and the counterpart in a flow-conducting or fluid-conducting manner, and can preferably be connected to, in particular screwed together with, the element or the counterpart, respectively.

24. A method for connecting an element, in particular a sensor or a system connector, to a counterpart in a flow-conducting or fluid-conducting, in particular gas-conducting, manner, in particular to a component selected from the group consisting of: a pressure vessel, a valve, a valve assembly, a valve block and the like, using the system according to claim 1, comprising:
inserting or screwing the element, in particular an adapter body into the counterpart, in particular into an adapter housing,
creating a sealing effect of a second seal which is disposed in the fluid channel downstream of the first seal in an outflow direction of a fluid flowing through or flowing out through a fluid channel wherein the second seal is configured to seal a connecting region between the fluid channel and the element, in particular the adapter body, and
opening or releasing the first seal by preferably moving a valve body of the first seal out of engagement or contact with a first sealing member of the first seal,
wherein the sealing effect of the second seal between the fluid channel and the element is created before the first seal is allowed to open or release, in particular is mechanically enabled.
